(19) United States
(12) Patent Application Publication
(10) Pub. No.: US 2017/0337579 A1
(43) Pub. Date: Nov. 23, 2017

(54) MEDIA COMMUNICATION

(71) Applicants: Ronald Charles Krosky, Lakewood, OH (US); Brendan Edward Clark, Rocky River, OH (US)

(72) Inventors: Ronald Charles Krosky, Lakewood, OH (US); Brendan Edward Clark, Rocky River, OH (US)

(21) Appl. No.: 12/692,600

(22) Filed: Jan. 23, 2010

Related U.S. Application Data
(60) Provisional application No. 61/147,070, filed on Jan. 23, 2009.

(51) Int. Cl. G06Q 30/02; H04L 12/58

(52) U.S. Cl. CPC G06Q 30/0251; H04L 51/02

(57) ABSTRACT

Systems, methods, and other embodiments associated with a media communication are described. In one embodiment, a system comprises an identification component to identify a media communication. The system also comprises an integration component to integrate a dynamic element with an adaptable part of the media communication, where the dynamic element is integrated seamlessly with the media communication.

### CROSS REFERENCE TO RELATED APPLICATIONS

This application claims the benefit of U.S. provisional application Ser. No. 61/147,070 filed on Jan. 23, 2009, which is hereby wholly incorporated by reference.

### BACKGROUND

A media communication can include a content that is disclosed to a user. For example, the media communication can be a signal and the content can be a television program. The television program may be displayed to the user by way of a television set. The television program can serve a variety different functions, including entertaining the user, informing the user, and others. Thus, a signal can carry a television program into a home of a user that serves a specific function.

### BRIEF DESCRIPTION OF THE FIGURES

The accompanying drawings, which are incorporated in and constitute a part of the detailed description, illustrate various example systems, methods, and other example embodiments of various innovative aspects. These drawings include:

FIG. 1 that illustrates one embodiment of a system with an integration component and an identification component,

FIG. 2 that illustrates one embodiment of a communication network,

FIG. 3 that illustrates one embodiment of a pre-integration scene and a post-integration scene,

FIG. 4 that illustrates one embodiment of a pre-integration scene and a post-integration scene,

FIG. 5 that illustrates one embodiment of a pre-integration scene and a post-integration scene,

FIG. 6 that illustrates one embodiment of a pre-integration scene and a post-integration scene,

FIG. 7 that illustrates one embodiment of a pre-integration communication and a post-integration communication,

FIG. 8 that illustrates one embodiment of a pre-integration communication and a post-integration communication,

FIG. 9 that illustrates one embodiment of a media communication with a first view type and a second view type,

FIG. 10 that illustrates one embodiment of a system with an evaluation component, an analysis component, and a calculation component,

FIG. 11 that illustrates one embodiment of a system with a monitor component,

FIG. 12 that illustrates one embodiment of a system with a collection component and a choice component,

FIG. 13 that illustrates one embodiment of a system with an identification component and a presentment component,

FIG. 14 that illustrates one embodiment of a system that includes an identification component and an integration component,

FIG. 15 that illustrates one embodiment of a method that includes making a selection,

FIG. 16 that illustrates one embodiment of a method that includes selecting an information content,

FIG. 17 that illustrates one embodiment of a method that includes identifying a media communication,

FIG. 18 that illustrates one embodiment of a method that includes integrating content,

FIG. 19 that illustrates one embodiment of a method that includes identifying a media communication,

FIG. 20 that illustrates one embodiment of an example system that can be used in practice of at least one innovative aspect disclosed herein, and

FIG. 21 that illustrates one embodiment of an example system that can be used in practice of at least one innovative aspect disclosed herein.

It will be appreciated that illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale. These elements and other variations are considered to be embraced by the general theme of the figures, and it is understood that the drawings are intended to convey the spirit of certain features related to this application, and are by no means regarded as exhaustive or fully inclusive in their representations.

The terms ‘may’ and ‘can’ are used to indicate a permitted feature, or alternative embodiments, depending on the context of the description of the feature or embodiments. In one example, a sentence states ‘A can be AA’ or ‘A may be AA’. Thus, in the former case, in one embodiment A is AA, and in another embodiment A is not AA. In the latter case, A may be selected to be AA, or A may be selected not to be AA. However, this is an example of A, and A should not be construed as only being AA. In either case, however, the alternative or permitted embodiments in the written description are not to be construed as injecting ambiguity into the appended claims. Where claim ‘x’ recites A is AA, for instance, then A is not to be construed as being other than AA for purposes of claim x. This is construction is so despite any permitted or alternative features and embodiments described in the written description.

### DETAILED DESCRIPTION

Described herein are example systems, methods, and other embodiments associated with media communication. An example communication may be a signal including audio and visual information. The signal may include data for a television program and the communication may be the television program. In one example, the television program is a television drama. The television drama can be filled with content. Example content includes scenes, individual shots, and advertisements. This content can be made up of different elements. In one example, a scene of the television drama can include many different elements. One example element could be a particular actor or face. Other example elements could include a background, a room, a picture on the room's wall, a vehicle, and so forth. Contextual features such as location, time of day, accent or vernacular, and other aspects can be elements of the communication. To provide a more specific example, one element may be a beverage can. For example, one scene may include a beverage can that can be seen, noises and interactions associated with the beverage can, and dialogue among characters discussing the beverage can. Other elements can be considered as well, and these lists and examples are considered in no way exhaustive.

Providing further detail on the specific example, the beverage can may include a logo or specific branding. The beverage can may be customized to a viewer set of the television drama. For example, viewers in Atlanta can see a Coca-Cola can while views in St. Louis see a Bud Light can. This allows for the beverage can to be customizable to the St. Louis views and Atlanta viewers. This customization can occur at various points along a distribution chain for the television drama. In one example, a local cable box is aware of viewers to a particular television set. If no viewer is under 21 years-old then a Bud Light can is shown. If a viewer is under 21 years-old, then a Coca-Cola can is shown. Thus, content of the communication can be customized to a viewer set.

The following paragraphs include definitions of selected terms discussed at least in the detailed description. The definitions may include examples used to explain features of terms and are not intended to be limiting. In addition, where a singular term is disclosed, it is to be appreciated that plural terms are also covered by the definitions. Conversely, where a plural term is disclosed, it is to be appreciated that a singular term is also covered by the definition.

It is to be appreciated that different dynamic elements can be integrated into a media communication at various locations and/or devices (e.g., devices where a viewer can receive the communication). This can invoke concepts as broad as wide-scale geography (e.g. Atlanta and St. Louis, above), and as specific as devices located in the same room. For example, a family in Atlanta could view a different integrated content than a family in Saint Louis while receiving the same media communication and viewing the same scene. Within one of those families, children in one room could receive an integrated dynamic element directed to children, and adults in another room receive an integrated dynamic element directed to an older audience. Within one of the rooms, still another different integrated dynamic element could appear on an individual's mobile device, the dynamic element directed to that individual, while the mobile device displays the same media communication. This can occur during one communication (e.g., TV show being watched by many people in many locations on many devices). In one example, the dynamic element can be directed to one product, a group of product, unrelated products, and others. While the above refers to any one device as “receiving” integrated content, the use of this terminology is intended in a non-limiting way and generally describes transmission, integration and display of content in the communication.

References to “one embodiment”, “an embodiment”, “one example”, “an example”, and so on, indicate that the embodiment(s) or example(s) so described may include a particular feature. The embodiment(s) or example(s) are shown to highlight one feature and no inference should be drawn that every embodiment necessarily includes that feature. Multiple usage of the phrase “in one embodiment” and others does not necessarily refer to the same embodiment; however this term may refer to the same embodiment. It is to be appreciated that multiple examples and/or embodiments may be combined together to form another embodiment.

“Computer-readable medium”, as used herein, refers to a medium that stores signals, instructions and/or data. A computer may access a computer-readable medium and read information stored on the computer-readable medium. In one embodiment, the computer-readable medium stores instruction and the computer can perform those instructions as a method. The computer-readable medium may take forms, including, but not limited to, non-volatile media (e.g., optical disks, magnetic disks, and so on), and volatile media (e.g., semiconductor memories, dynamic memory, and so on). Example forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, and other media from which a computer, a processor or other electronic device can read.

“Component”, “logic”, “module”, “interface” and the like as used herein, includes but is not limited to hardware, firmware, software stored or in execution on a machine, a routine, a data structure, and/or at least one combination of these (e.g., hardware and software stored). Component, logic, module, and interface may be used interchangeably. A component may be used to perform a function(s) or an action(s), and/or to cause a function or action from another component, method, and/or system. A component may include a software controlled microprocessor, a discrete logic (e.g., ASIC), an analog circuit, a digital circuit, a programmed logic device, a memory device containing instructions, a process running on a processor, a processor, an object, an executable, a thread of execution, a program, a computer and so on. A component may include one or more gates, combinations of gates, or other circuit components. Where multiple components are described, it may be possible to incorporate the multiple components into one physical component. Similarly, where a single component is described, it may be possible to distribute that single component between multiple physical components. In one embodiment, the multiple physical components are distributed among a network. By way of illustration, both/either a controller and/or an application running on a controller can be one or more components.

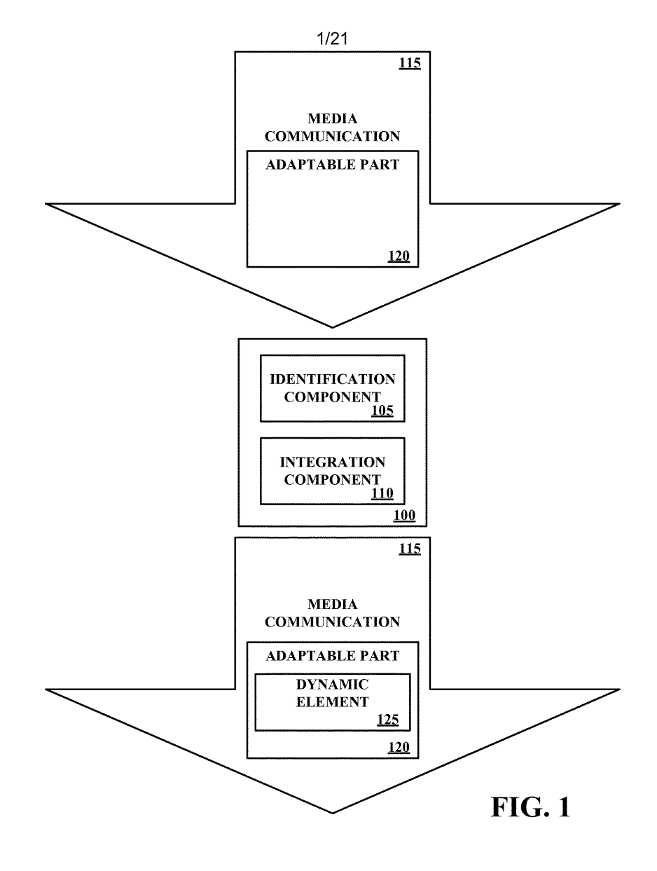

FIG. 1 illustrates one embodiment of a system 100 with an integration component 105 and an identification component 110. The identification component 105 can identify a media communication 115. Example media communications 115 can include a television program, streamed internet content, a billboard, a movie, and any number of other forms. The identification component 105 can perform active monitoring or passive monitoring in identifying the media communication 115. In one example, active monitoring can be seeking out signals and determining if the signal is a communication and/or if a communication is the media communication 115. In one example, passive monitoring can be the identification component 110 identifying the media communication 115 in response to receiving an instruction to identify the media communication 115. In one embodiment, upon receiving a signal, the identification component 105 analyzes the signal to determine if the signal is a media communication 115 for the purposes of system 100. In one embodiment, the identification component 105 identifies an adaptable part 120 of the media communication 115.

The integration component 110 can integrate a dynamic element 125 with the adaptable part 120 of the media communication 115. A dynamic element can be an aspect of a media communication that can be changed. Elements can be intended by the media communication's creator to be dynamic, or the systems and methods described herein can overwrite aspects that were developed in a static fashion. Inasmuch as the elements can be dynamic, the systems and methods described herein can, in one embodiment, adapt and augment portions of the media communication (e.g., particular people or items in a TV show) to exhibit more than what is originally captured (e.g., something different than was originally filmed). In one embodiment, the dynamic element 125 is integrated seamlessly with the media communication 115. In one embodiment, a scene of the media communication 115 includes an adaptable part 120 that is set aside to be integrated with the dynamic element 125. In this embodiment, the adaptable part is a portion of the scene. In one example, the adaptable part 120 is a blue screen area. In one embodiment, a blue screen area can be an area chroma keyed to facilitate video editing, and particularly adding or removing elements of a scene. Blue screen, green screen or chroma key technology is just one means available to integrate, add, mask, remove or otherwise alter elements of a scene. In other embodiments, the adaptable part is not a blue screen area, and the integration component 110 integrates content onto an adaptable part that is identified on-the-fly, or is integrated by means other than blue screen technology.

The integration component 110 can cause a specific dynamic element 125 to be placed over the blue screen area. In one example, the specific dynamic element 125 is a Coca-Cola can. When the media communication 115 is displayed, the dynamic element 125 is displayed as the Coca-Cola can and not the blue screen element.

In one embodiment, the integration component 110 integrates the dynamic element 125 on an adaptable part 120 not intended to be modified. For example, an adaptable part 120 of the scene can be a Coca-Cola beverage can. The integration component 110 can cause a Pepsi-Cola beverage can to replace the Coca-Cola beverage can. The Pepsi-Cola can may be the adaptable part 120 while the Coca-Cola can is the dynamic element 125.

Selection of the dynamic element 125 can be based, at least in part, on a set of recipients (e.g., one or more recipients), or characteristics thereof. In one example, specific individuals viewing or anticipated to view the media communication 115 can be evaluated based on age, race, gender, sexual orientation, viewing history, individual preferences, career, income, recent purchases, and/or other demographic or personal information. A result from this evaluation can be used in selecting the dynamic element 125 and/or an adaptable part 120 upon which to integrate the dynamic element 125 (e.g., an adaptable part to integrated a specific dynamic element, an adaptable part upon which a dynamic element should be integrated, and others). In one example, an artificial intelligence component can be used to determine content to select.

The integrated dynamic element 125 can be seamless with the media communication 115. Being seamless can include that a viewer is not aware that dynamic element integration occurs. Being seamless can include that the dynamic element 125 is thematic with the media communication 115. A seamless integration can be unnoticeable to a viewer, and appear as if the integrated dynamic element was original to the communication. In one example, if elements of one scene are soda cans, then the dynamic element 125 may also be a soda can. The dynamic element 125 can also be evaluated for appropriateness or ensure the element “makes sense” in a scene. In one example, if a scene takes place in the 1800s, the dynamic element 125 might not be a video game system since the video game system may not be time appropriate. However, for companies that have a longer brand life, an earlier product could be displayed to accommodate the period piece. In one example, a piece for the 1930s can have a Coca-cola glass bottle integrated onto a scene as opposed to an aluminum can. Processes can be arranged to ensure dynamic portions are filled even if the intended element or aspect is found to be inappropriate (e.g., inappropriate content is selected over a blue screen being presented). However, context alone can be dispositive to a factor of harmoniousness. In one embodiment, a harmonious integration can appear seamless within the scene, such that a viewer would believe the integrated content had been presented in the observed fashion at the time of communication production.

While the dynamic element 125 and adaptable part 120 are discussed in relation to a scene element, it is to be appreciated that other embodiments can be practiced. In one example, the adaptable part 120 is a 30-second commercial break. In one example, the dynamic element 125 can be a 30-second commercial seamlessly inserted into the break or that seamlessly replaces another 30-second commercial.

In one embodiment, the integration component 110 integrates dynamic content on a recorded media communication 115 (e.g., a media communication recorded on a digital video recorder). In one example, the integration component 110 can integrate a different dynamic element on one adaptable part for different viewings of the same media communication 115.

In one embodiment, a dynamic element 125 can be selected and then a media communication 115 that is an appropriate host for the dynamic element 125 can be identified (e.g., identified by the identification component 105) and selected, or created if no appropriate host can be identified. Dynamic element selection can occur in accordance with aspects disclosed herein. The dynamic element 125 can be integrated upon the media communication 115 (e.g., the adaptable part 120 of the media communication 115) by the integration component 110.

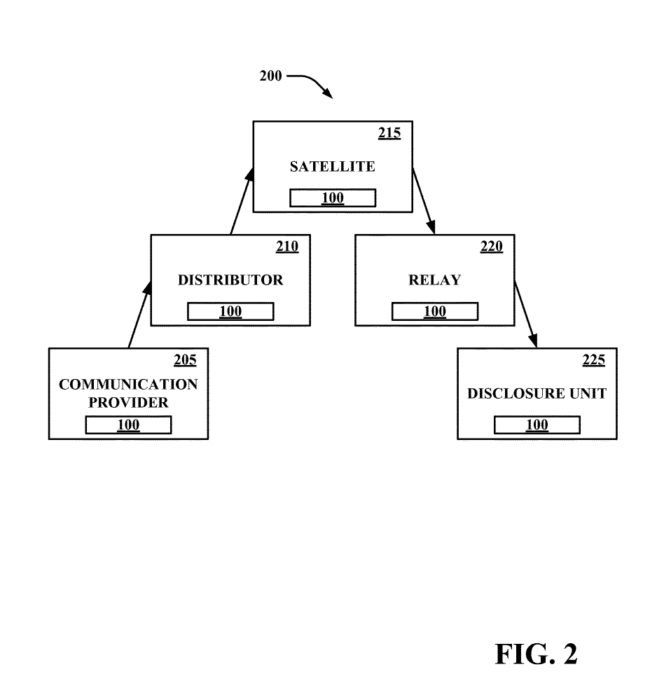

FIG. 2 illustrates one embodiment of a communication network 200. A media communication can travel along the communication network 200. The communication network 200 includes a communication provider 205 (e.g., media communication provider), distributor 210, satellite 215, relay 220, and a disclosure unit 225. The communication provider 205 can collect the media communication from a media communication originator (e.g., an entity that produces the media communication). In one embodiment, the communication provider 205 includes the media communication originator.

The distributor 210 collects the media communication from the communication provider 205. The distributor 210 can include a logic that determines where the media communication should be sent. Based on a determination made by the logic, the media communication can be sent to the satellite 215 that transfers the media communication to a disclosure unit 225. In one embodiment, the relay 220 is employed to transfer the media communication to the disclosure unit 225. The disclosure unit 225 can include a cable box, a media player, a television (e.g., standard definition, high definition, capable of displaying three-dimensional content, and others), a computer screen, a cellular telephone, a personal digital assistant, a digital video recorder, digital video disk technology, and others.

The components of various systems disclosed herein can be located or operate in one or more physical or logical places along the path between a producer of a media communication and the eventual set of recipients for the media communication. In one embodiment, the integration component 110 of FIG. 1 functions, at least in part, local to the set of recipients (e.g., the integration component 110 of FIG. 1 functions at the disclosure unit 225). In one embodiment, 1, the integration component 110 of FIG. 1 functions, at least in part, local to a distributor of the media communication (e.g., the distributor 210). In one embodiment, the communication provider 205, the satellite 215, the relay 220, or a combination thereof integrates as part of the distributor 210. In one embodiment, the integration component 110 of FIG. 1 functions, at least in part, local to a producer of the media communication (e.g., the communication provider 205). In one embodiment, the system 100 (e.g., the whole system 100, at least one component of the system 100, and others) is located on a communication provider 205, distributor 210, satellite 215, relay 220, a disclosure unit 225, or a combination thereof. In one example, the integration component 110 is distributed across the communication provider 205 and distributor 210.

While the communication network 200 is depicted as including five units, it is to be appreciated that the communication network 200 can function with more or less units. In one example, the communication network 200 functions without the relay 220. In one example, the communication network 200 functions with a separate content provider. In addition, while this specific communication network is shown, it is to be appreciated that the system 100 can function independent of a communication network 200. In one example, the system 100 resides on a personal computer and the media communication is displayed on a monitor of the personal computer.

In one embodiment, a dynamic element is integrated (e.g., by the integration component 110 of FIG. 1) with an adaptable part of the media communication after creation of the media communication. In one embodiment, the dynamic element is integrated at a communication creator, but after creation occurs. In one embodiment, the dynamic element is integrated at the disclosure unit 225. In one embodiment, the system 200 uses Tru2way and/or OpenCable technology. In one embodiment, aspects disclosed herein function in conjunction with Enhanced TV Binary Interchange Format (EBIF) specification (e.g., version 105). These are merely examples of possible embodiments, and not intended to exclude alternatives.

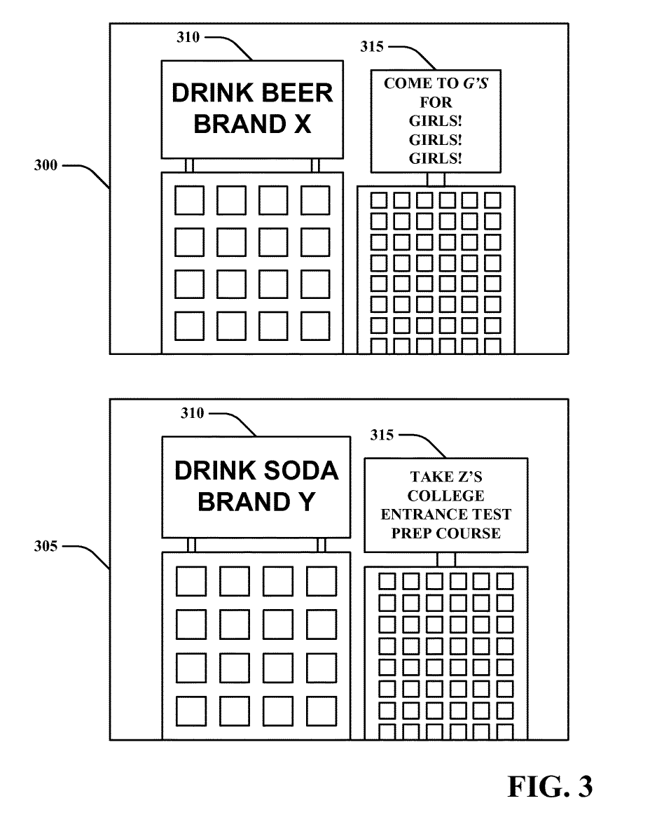

FIG. 3 illustrates one embodiment of a pre-integration scene 300 and a post-integration scene 305. The pre-integration scene 300 may be found in a media communication after being originally produced by a content provider. The post-integration scene 305 may be found in the media communication after the system 100 of FIG. 1 functions upon the media communication.

In one example, the pre-integration scene 300 is a scene depicting a first building with a first sign 310 and a second building with a second sign 315. The first sign 310 advertises beer while the second sign 315 advertises an adult entertainment establishment. A viewer set (e.g. set of recipients) with parents and children may find content of the first sign 310 and the second sign 315 objectionable.

Therefore, the system 100 of FIG. 1 can operate on the pre-integration scene 300 to make the scene less objectionable. The viewer set can be analyzed to determine replacement content that the viewer set would find less objectionable. The viewer set can also be analyzed to determine what content the viewer set would likely find objectionable. Analysis can occur on a viewing history profile retained over previous viewing sessions. The integration component 110 of FIG. 1 can suppress the first sign 310 and second sign 315. Suppression can occur by way of deleting data portions for the first sign 310 and second sign 315 or masking data portions for the first sign 310 and second sign 315. Alternatively, or simultaneously, new dynamic elements can replace, mask, obscure, or otherwise alter the objectionable content to the satisfaction of the viewer set. In some instances, several portions of a scene can be designated or identified as an adaptable part, in order to allow finer control over content that may or may not be objectionable to certain audiences.

The first sign 310 and second sign 315 can be considered adaptable parts of the media communication (e.g., a scene of the communication). The integration component 110 of FIG. 1 causes the first sign 310 and second sign 315 to change in the post-integration scene 305. The change can be based on the viewer set. In one example, the viewer set can be a high school student. With a high school student, it may be ill-advised to advertise a beer and adult entertainment establishment. Therefore, a beer advertisement on the first sign 305 can be replaced by a soda advertisement or other age-appropriate dynamic elements. In this case, the soda advertisement can be considered a dynamic element.

Context of the viewer set can be taken into account when selecting and integrating content. In one example, the high school student can be preparing for a college entrance test. An advertisement can be selected for the second sign 310 that advertises a college entrance test prep course. Thus, a dynamic element can be age appropriate as well as something of particular interest to a user and/or something a user might want to see. Recognition of possible user interests or preferences can be accomplished through a variety of means such as those described elsewhere within this specification. With the first sign 305 and second sign 310 being background signs (e.g., a sign that character in a scene does not explicitly interact with) in the scene, these replacements can be considered seamless with the communication.

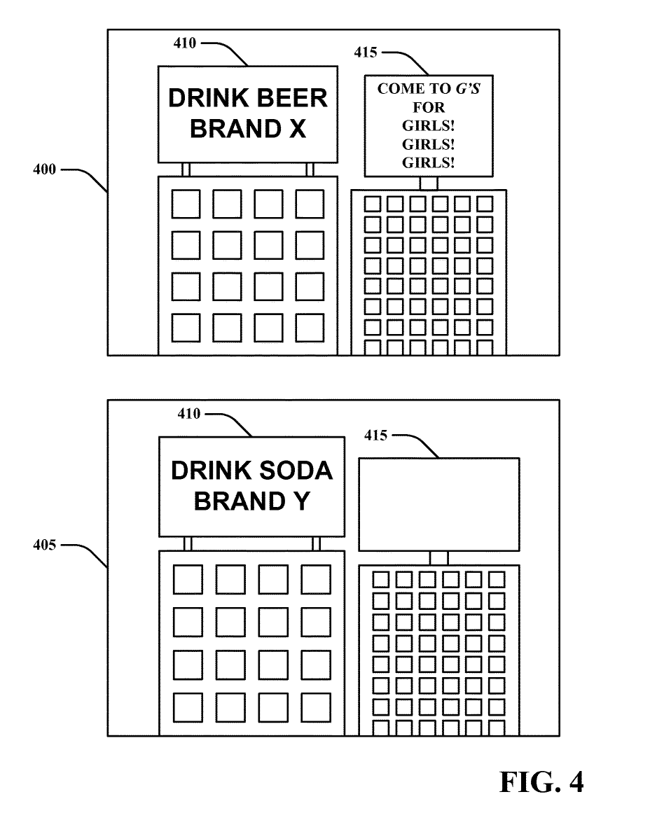

FIG. 4 illustrates one embodiment of a pre-integration scene 400 and a post-integration scene 405. The pre-integration scene 400 can include a first sign 410 and a second sign 410. The pre-integration scene 400 can match to the pre-integration scene 300 of FIG. 3. In the post-integration scene 405, the first sign 415 can be replaced with a dynamic element the same as the first sign 315 in FIG. 1 as shown in the post-integration scene 305 of FIG. 3.

In the post-integration scene 405, a comparable replacement can be found. In one example, a viewer set includes a viewer that is sixteen years-old. A soda advertisement can be the comparable replacement for a beer advertisement. Thus, the integration component 110 of FIG. 1 can replace the beer advertisement for the first sign 415 with a soda advertisement. This replacement is shown in comparison between the pre-integration scene 400 and the post integration scene 405.

However, an adult entertainment establishment may not have an available comparable replacement. In one example, the system 100 of FIG. 1 uses a local data library to store content. An algorithm can be used to select content from the local data library for integration on an adaptable part. The algorithm can function to identify a comparable replacement. Without a comparable replacement, a blank dynamic element can be selected. Thus, the integration component 110 of FIG. 1 integrates the blank dynamic element on the adaptable part. Blank dynamic element integration is shown in comparison between the second sign 420 in the pre-integration scene 400 and the second sign 420 in the post integration scene 405. Blank dynamic element integration can include deleting a part of the adaptable part, masking the part of the adaptable part, or integrating a dynamic element to produce a replacement sign. In one embodiment, the second sign 420 is deleted from the post-integration scene and a sky background is integrated in place of the second sign 420. Alternatively, a generic replacement can be used from the library in order to avoid disrupting the communication. Generic content can be one or more “stock” dynamic elements used to fill in adaptable parts that would otherwise be blank or designated for replacement. Generic dynamic elements can take a diverse range of forms and varieties, and can originate from local and/or remote sources, and even be fetched on-the-fly via one or more networks or other connections.

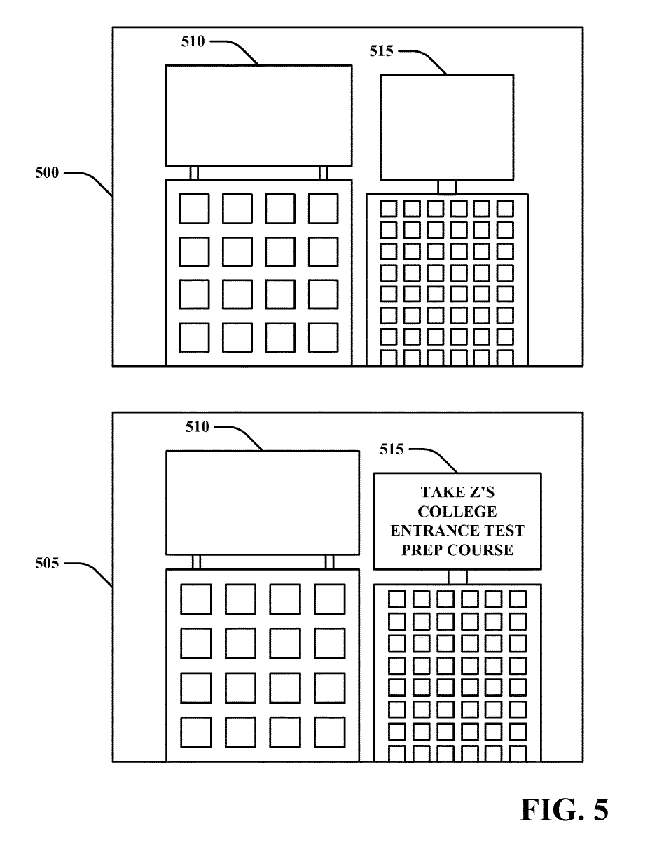

FIG. 5 illustrates one embodiment of a pre-integration scene 500 and a post-integration scene 505. The pre-integration scene 500 can include a first sign 510 and a second sign 510. In the pre-integration scene 500, the first sign 515 and second sign 520 can be blank. The first sign 515 and the second sign 520 being blank can be an example of a media communication specifically designed to have a replacement. In one example, the first sign 515 and the second sign 520 in the pre-integration scene 500 can be blue screens.

It is to be appreciated that blue screen and similar terms used herein are used to describe chroma keying and is not intended to limit practice to an actual blue screen. In one example, a green screen may be used. In one example, a different chroma keying technique other than using a color screen may be used. Other techniques such as overlaying, image mapping, and tags, pointers or other designations to identify sections for visual recognition or other computer processing can be employed alternatively or in conjunction with other described means. This list of examples is considered non-exhaustive, but merely seeks to suggest some possibilities for identifying portions of the communication that are intended to be dynamic, or can be made dynamic, through any number of relative (e.g. appropriate shape recognized within the communication) or absolute (e.g. geometry of portion of scene designated) algorithms.

In the post-integration scene 505, a dynamic element can be integrated upon the second sign 520. This integration can be performed by the integration component 110 of FIG. 1. In one example with the post-integration scene 505, if no dynamic element is selected then the blue screen can remain or a blank element can be integrated. A blank element can be a generic element provided by the system to fill adaptable parts where no other appropriate element can be integrated. Generic elements can be stored at any point along the distribution paths of communication, from the creator of the media communication through a device at which the recipient set views the media communication. In some instances, a generic element could be searched and integrated on-the-fly using network connections. Alternatively, the dynamic element in question could be removed altogether and the dynamic space blended into the background, rather than display or generic or blank element. For example, if an appropriate advertisement cannot be shown on a billboard intended to be a dynamic element, the billboard could be “erased” from the scene and the background (e.g., sky) could replace the element. In one example, a dynamic element is selected based, at least in part, on a purchaser selecting a specific dynamic element to be integrated on an adaptable part of a media communication. If a purchaser does not come forward, is not chosen, or make a selection, then a default dynamic element can be selected and integrated on the first sign 510 in the post-integration scene 505.

In one embodiment, FIGS. 3, 4, and 5 can be an example of where the adaptable part is a portion less than whole of the media communication and where the dynamic element is a replacement dynamic element.

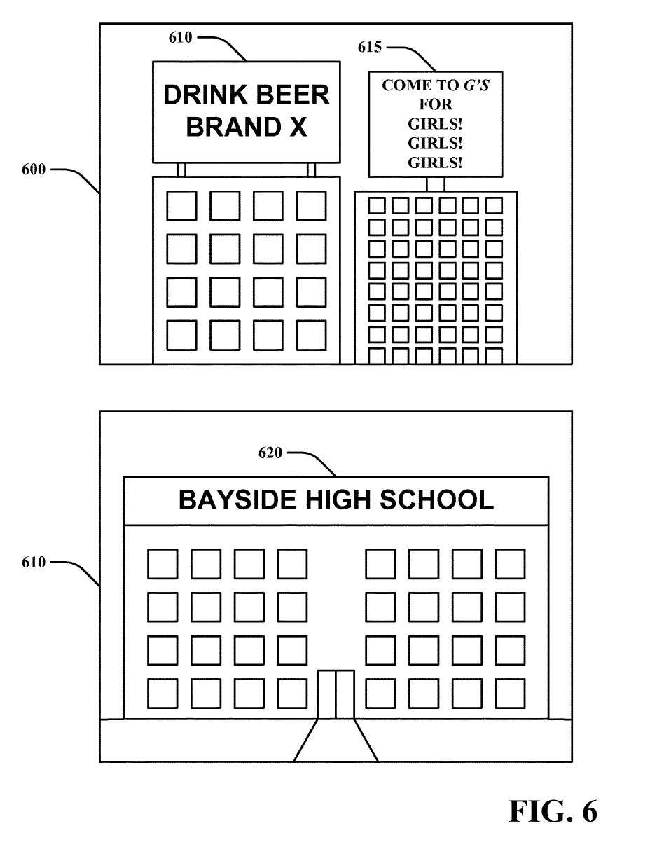

FIG. 6 illustrates one embodiment of a pre-integration scene 600 and a post-integration scene 605. The pre-integration scene 600 can include a first sign 610 and a second sign 610. In the pre-integration scene 600, the first sign 610 and second sign 615 can be blank. The integration component 110 of FIG. 1 can treat the entire pre-integration scene as an adaptable part. Thus the entire pre-integration scene 600 can be replaced by integrating a dynamic element on the adaptable part. For example, two buildings and signs in pre-integration scene 600 can be replaced with a high school 620 in the post-integration scene.

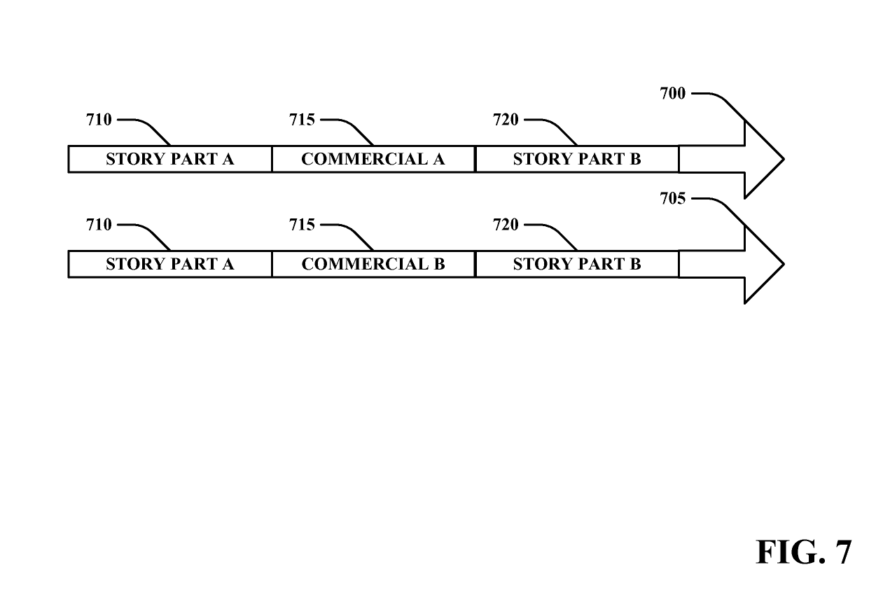

FIG. 7 illustrates one embodiment of a pre-integration communication 700 and a post-integration communication 705. In one embodiment, the pre-integration communication 700 and the post-integration communication 705 are streaming video. The pre-integration communication 700 can include story part A 710, a commercial part 715 with ‘commercial A’, and story part B 720. The commercial part 715 can be an adaptable part. The commercial part 715 in the pre-integration communication can be a commercial advertisement named ‘commercial A’. In one embodiment, the commercial advertisement is a 30-second video advertisement.

The integration component 110 of FIG. 1 can integrate a dynamic element on the commercial part 715. In one embodiment, the dynamic element is a 30-second video advertisement named ‘commercial B’. The post-integration communication can include story part A 710, the commercial part 715 with ‘commercial B’, and story part B 720. In one embodiment, ‘commercial A’ and ‘commercial B’ advertise one product, however ‘commercial B’ can be selected for integration because it is predicted to have a better influence on a recipient set or the recipient set is overexposed to ‘commercial A’ (e.g., a threshold of views for ‘commercial A’ is reached). In one embodiment, ‘commercial A’ and ‘commercial B’ are unrelated and/or advertise different products. Either, neither or both commercials can occupy the same advertising space during the same communication at different locations and for display to different recipient sets or subsets.

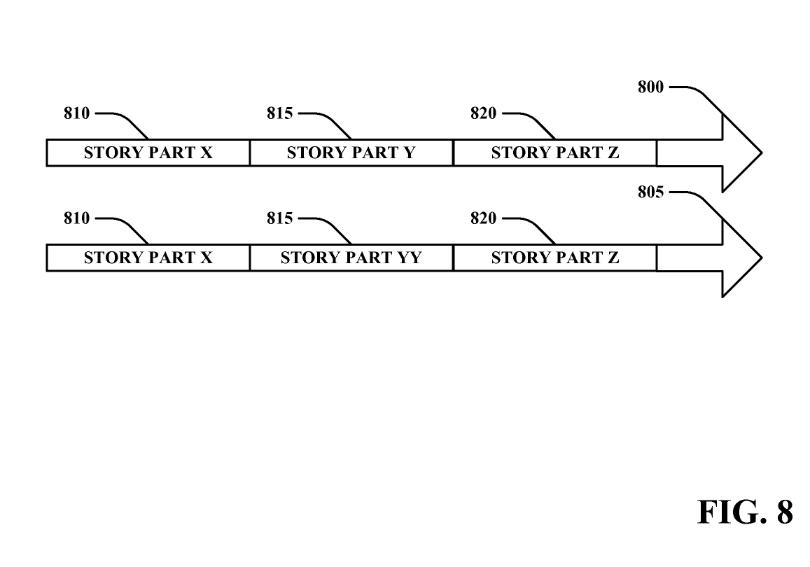

FIG. 8 illustrates one embodiment of a pre-integration communication 800 and a post-integration communication 805. In one embodiment, the pre-integration communication 800 and the post-integration communication 805 are streaming video. The pre-integration communication 800 can include story part X 810, an adaptable part 815 named ‘story part Y’, and story part Z 820. In one embodiment, story part X 810 and story part Z 820 are adaptable parts.

The integration component 110 of FIG. 1 can integrate a dynamic element on the adaptable part 815. The dynamic element can be a video portion of the post-integration communication 805. The dynamic element can be story part YY. Story part YY can replace story part Y seamlessly such that a user does not realize story part YY is a dynamic element integrated upon an adaptable part. In one embodiment, story part YY is an alternative ending or story part to story part Y.

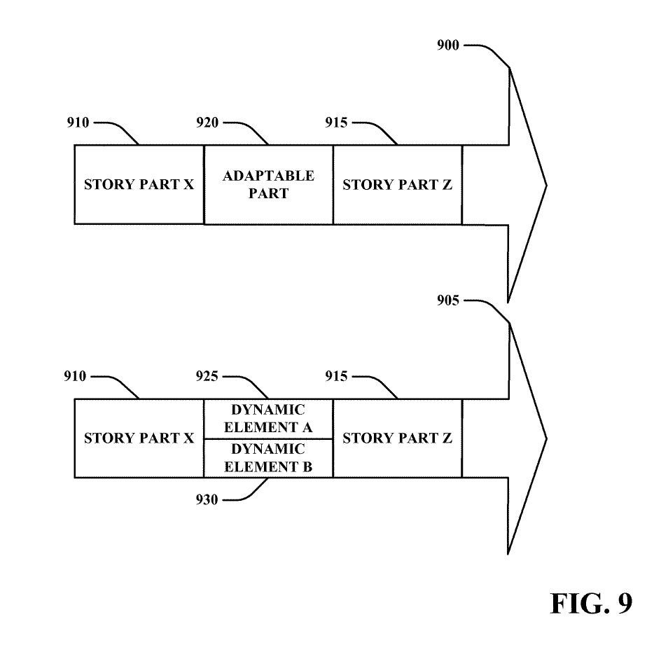

FIG. 9 illustrates one embodiment of a media communication with a first view type 900 and a second view type 905. The first view type 900 and the second view type 905 can be different views of the same media communication. The media communication can include story part X 910 and story part Z 915. In the first view type 900, an adaptable part 920 is shown. The adaptable part 920 can be where a ‘story part Y’ may be inputted. When the media communication is sent, two scenes can be supplied. A choice can be made on which scene to integrate and the integration component 110 of FIG. 1 can integrate the scene. The second view type 905 shows two possible scenes as dynamic element A 925 and dynamic element B 930. In one embodiment, dynamic element A 925 can be a romantic scene for a movie that has nudity while dynamic element B 930 can be a romantic scene for the movie without nudity. Selection on if dynamic element A 925 or dynamic element B 930 should be integrated can be based, at least in part, on a religious belief of the viewer set, a response to a question (e.g., a question asking the viewer set a content to display), and others.

In one embodiment, FIGS. 6, 7, 8, and 9 are examples of where the dynamic portion is a scene of the communication and where the content is a replacement scene. In one embodiment, FIGS. 7, 8 and 9 are examples of where the communication is a video and where the dynamic portion is a visual aspect of the video.

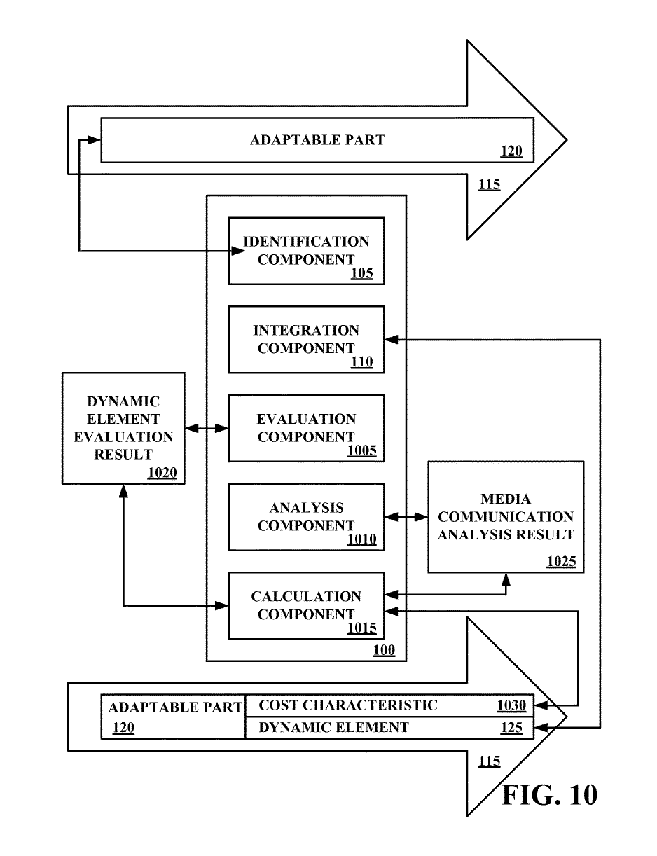

FIG. 10 illustrates one embodiment of a system 1000 with an evaluation component 1005, an analysis component 1010, and a calculation component 1015. The system 1000 can include an identification component 105 to identify a media communication 115 with an adaptable part 120. An integration component 110 can integrate a dynamic element 125 onto the adaptable part 120.

In one embodiment, the dynamic element integration is associated with a cost. In one example, a company can be charged an amount of money for integrating the dynamic element 125 onto the adaptable part 120. In one embodiment, a company can be charged an amount of money in exchange for having a number of dynamic elements integrated (e.g., over a period of time). In one example, different integrations carry different weight. A dynamic element 125 with a higher weight can be more expensive. In one example, a dynamic element 125 that is presented to a teenager can be given a higher weight (e.g., cost more) than a dynamic element 125 presented to an elderly couple. In one example, a dynamic element 125 integrated in an important scene in a story (e.g., a climactic ending) can be weighted higher that a dynamic element 125 integrated in a scene depicting a conversation of little importance in the story. In one example, a dynamic element 125 integrated prominently in a scene can be weighted higher than a dynamic element 125 integrated in a background of the scene. In one example, a dynamic element 125 integrated in a conversation (e.g., seamlessly replacing an actor saying ‘soda A’ with ‘soda B’) can be weighed higher than a dynamic element 125 integrated visually (e.g., a can of ‘soda A’ on a table being replaced with a can of ‘soda B’). The weight, cost, and/or value of a particular integration or set of integrations can be predetermined, or determined automatically based on algorithms that evaluate the action, timing, and/or placement in a media communication, audio or visual real estate (e.g., size, position, volume, emphasis, et cetera), and/or other factors. These examples are understood to be non-exhaustive, and other variations will be apparent to those skilled in the art.

An evaluation component 1005 can be used to evaluate the dynamic element 125 to produce a dynamic element evaluation result 1020. An analysis component 1010 can analyze the media communication 115 according to a cost metric to produce a media communication analysis result 1025. A calculation component 1015 can assign a cost characteristic 1030 to the dynamic element 115 based, at least in part, on the dynamic element evaluation result 102 and the media communication evaluation result 1025.

In an embodiment, the evaluation component 1005, analysis component 1010, and/or calculation component 1015 operate before the media communication 115 is displayed (e.g., displayed to an end viewer). One or more of these components can identify one or more possible opportunities to integrate dynamic elements and classify available integration opportunities as a dynamic element set for any given portion of a communication. Dynamic elements of a potential dynamic element set can be individually evaluated or evaluated in subgroups by the evaluation component 1005. The potential dynamic element set as a whole can also be evaluated by the evaluation component 1005. Example analysis can include identifying a dynamic element 125, identifying an appropriate size of the dynamic element 125 (e.g., if a small logo would be visually distorted if the small logo was integrated on a large billboard), identifying element dynamic element content, and others.

In one embodiment, the analysis component 1010 can analyze the media communication 115 according to a cost metric (e.g., a metric used to determine how expensive it is integrate on the adaptable part 120). In one example, the adaptable part 120 is classified by the analysis component 1010 as high price, medium price, or low price. In one embodiment, a near infinite number of price (or other) classifications can be assigned in these and other instances. Classification can be based, at least in part, on size of the adaptable part 120, importance of a scene in a story upon which the adaptable part 120 resides, what individuals are viewing the media communication 115, where the media communication 115 is being displayed (e.g., in a case of a three-tiered price system, a home of an upper-class neighborhood, a business, a sports bar, and others), and others. In one embodiment, adaptable parts overlap (e.g., one large adaptable part can also be two smaller adaptable parts).

Similar to that set forth above, inn some example embodiments, a dynamic element set can be determined for the adaptable part 120. In one example, the media communication 115 is analyzed by the analysis component 1010. Based on the media communication analysis result 1025, adaptable parts can be identified and potential dynamic elements can be selected.

In one embodiment, the system 1000 notifies companies of a cost characteristic 1030 for integrating a dynamic element upon the adaptable part. The cost characteristic can be calculated by the calculation component 1015. In one example, the cost characteristic 1030 is how much it costs to integrate a dynamic element 125 upon the adaptable part 120. In other embodiments, the cost characteristic can relate to a particular communication, or a portion or attribute thereof, or other calculated or arbitrary values. The cost characteristic can include fixed and/or variable components. These descriptions of the cost characteristic are merely examples and not intended to limit realization of the cost characteristic, but rather intended to generally offer guidance as to its accomplishment with brevity.

In one embodiment, the cost characteristic 1030 is used in associating integration of the dynamic element 125 with a contract. In one example, the cost characteristic 1030 is how much of a contract term is met by integrating the dynamic element 125 upon the adaptable part 120. A company can agree to pay a sum of money for a number of integrations. Some integrations can cost more than others (e.g., due to adaptable part weighing, dynamic element weighing, and other fixed and variable values). The cost characteristic 1030 can associate with a portion of the sum of money (e.g., the cost characteristic meets X % of the sum of money for the number of integrations). The cost characteristic may not be fixed for every conceivable integration, but can be flexible depending upon specific instances. For example, if an advertisement for an attorney in San Antonio is integrated onto an advertising space during a hockey game, the cost characteristic of integrations can vary inversely with the distance of a set of recipients from San Antonio, how many people watch the hockey game, the score of the hockey game, and others. In some embodiments, a threshold cost characteristic can be set, and a potential purchaser of dynamic integrations can opt out of paying for an integration if the threshold cost characteristic is not met. Referring back to the previous example, the hockey game may be broadcast nationally and feature teams from San Antonio, Tex. and Cleveland, Ohio. An adaptable part of the broadcast may be a board sign underneath a penalty box. The attorney in San Antonio may offer to pay for an advertisement for her services to be integrated on the board sign. The cost characteristic can be calculated based on audience exposure for the board time. In one embodiment, the cost characteristic goes up when a penalty occurs and/or when the board sign is shown. However, the cost characteristic can use desired exposure in calculation. In one example, since the game is broadcast nationally fans in Cleveland may see the game. An attorney in San Antonio may be of little to no value to the fans in Cleveland. Therefore, when fans in Cleveland see the board sign, the cost characteristic does not go up while when fans in San Antonio see the board sign the cost characteristic does go up. In one or more embodiments, the system 1000 can provide for an alternative dynamic element where a cost characteristic is above or below a threshold (e.g., integration is of too little value, integration is too costly).

In one embodiment, an adaptable part 115 is analyzed by the analysis component 1010 and the media communication analysis result 1025 is an adaptable part analysis result. The calculation component 1015 calculates a cost characteristic 1030 for integrating a dynamic element 120 upon the adaptable part 115. In one example, companies are notified of the cost characteristic 1030. These companies can determine if they pay for the integration. This determination can be made automatically, manually, a combination thereof. The determination can additionally be accomplished as a pre-scheduled event, in real-time, or a combination thereof. If a company agrees to pay for the integration, then the company can provide the dynamic element 120 (or a plurality thereof) and the integration component 110 can integration the dynamic element 120 upon the adaptable part 115.

In one embodiment, the system 1000 identifies the adaptable part 120, selects the dynamic element 125, integrates the dynamic element 125 upon the adaptable part 120, and determines a cost characteristic for the dynamic element 125. In one example, the cost characteristic is a price for performing the integration. After the integration is performed, a company can be billed for the integration, a credit account can be debited, and others. While integration is discussed with payment, it is to be appreciated that integration can occur without payment or an associated financial cost. The cost characteristic (e.g., price) can be determined and flexible in ways similar to those described for the cost characteristic above, as well as other ways that are appreciable to those skilled in the art.

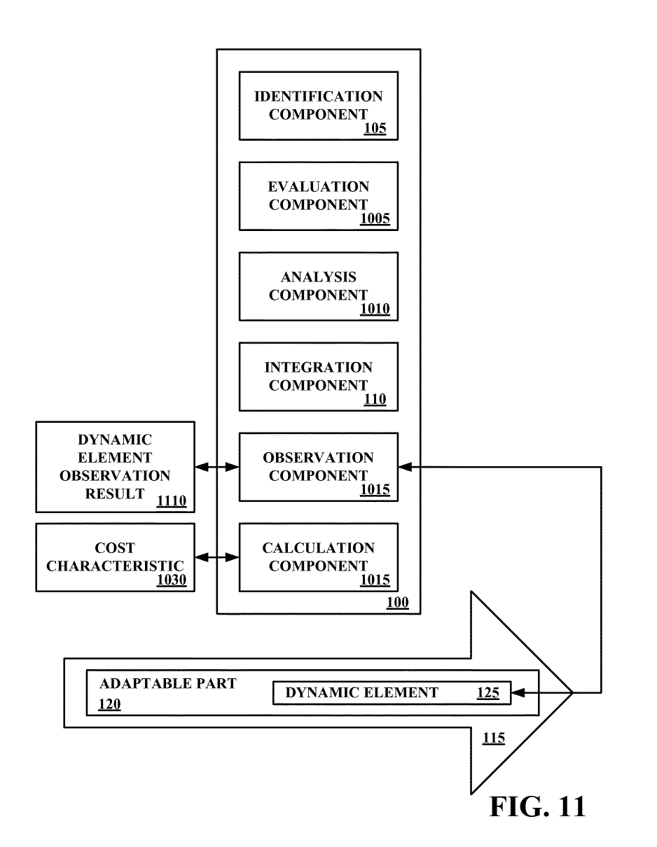

FIG. 11 illustrates one embodiment of a system 1100 with a monitor component 1105. The system 1100 can include an identification component 105, evaluation component 1005, analysis component 1010, integration component 110, monitor component 1105, and calculation component 1015. In one embodiment, the evaluation component 1005, analysis component 1010, and/or calculation component 1015 can operate after the media communication 115 is displayed (e.g., displayed to an end viewer).

In one embodiment, the calculation component 1015 assigns a cost characteristic to the dynamic element 125 that is integrated on an adaptable part 120 of a media communication 115. In one example, the cost characteristic can be an amount a company pays for dynamic element integration.

In one embodiment, a reaction to the dynamic element 125 can be used in determining the cost characteristic. The observation component 1105 can observe a reaction (e.g., viewer reaction, monitor reaction, and others) to the dynamic element 125. The observation component 1105 can produce a dynamic element observation result 1110. The dynamic element observation result 1110 can be used in assigning the cost characteristic. In one embodiment, the calculation component 1015 uses the dynamic element observation result 1105 to determine the price characteristic 1030.

A company may be willing to pay more for an integrated dynamic element that has a high impact on a viewer set. A reaction of the viewer set can be observed and used in determining a final price. Example reaction can include, but is not limited to, what viewers watch the dynamic element 125, how individuals feel emotionally after viewing the dynamic element 125, attention span of individuals when dynamic element 125 is displayed, if a viewer purchases an advertised item presented in the dynamic element 125 (e.g., within a window of time), and others.

Where visual watching aspects are discussed herein, it is to be appreciated that other dynamic element appreciation can be applied as well. In one example, when a viewer set is discussed, the viewer set can watch television, listen to a radio, view pages the Internet, smell odors specific to a story (e.g., at a play, an sound emitting from a chair speaker), and others. These examples are but a few possible means of conveying subject matter to a user, and not considered to be a comprehensive list. However, one of ordinary skill in the art will appreciate the spirit of such description for purposes of setting forth the meaning of these and other features.

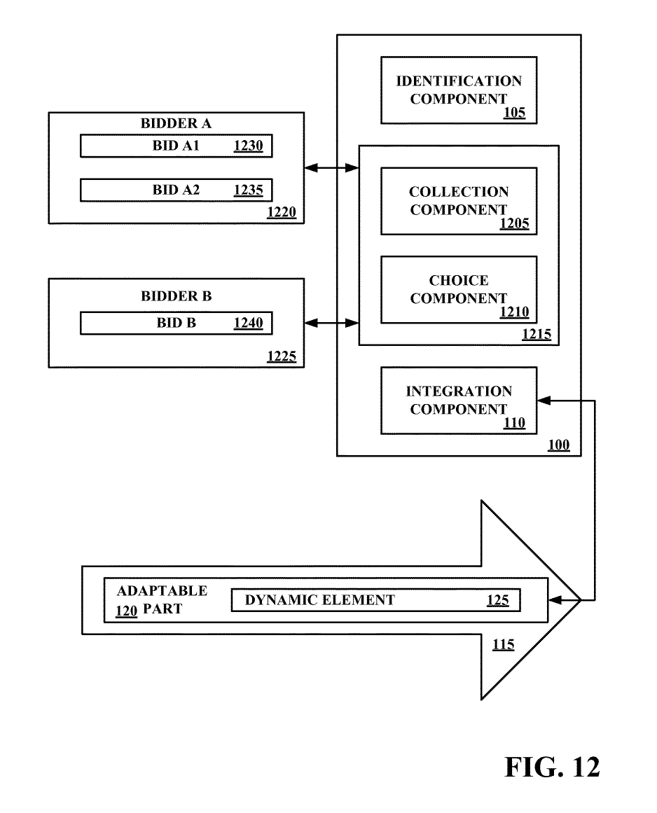

FIG. 12 illustrates one embodiment of a system 1200 with a collection component 1205 and a choice component 1210. An auction can occur to determine a dynamic element 125 for integration on an adaptable part 120 of a media communication 115 by an integration component 110. An identification component 105 can identify the media communication 115 and identify the adaptable part 120 of the media communication 115.

In one embodiment, an auction component 1215 can hold an auction to determine what dynamic element 125 is integrated upon the adaptable part 120. The auction component 1215 can notify entities through a notification that an adaptable part 120 is available for integration. The notification can include, for example, a description of a nature of the adaptable part 120, physical dimensions of the adaptable part 120, expected cost for integrating dynamic element 125 on the adaptable part 120, information related to a scene upon which the adaptable part 120 is located (e.g., actors in the scene, time frame of the scene, length of the scene, and others), and others. In one embodiment, the auction component 1215 can select bidders upon which the notification is sent based, at least in part, on content of the scene.

In one embodiment, bidding is open (e.g., the notification is sent over open airwaves and a company receiving the notification can bid). In one embodiment, bidding is semi-closed (e.g., the notification is sent over open airwaves and registered companies can bid). In one embodiment, bidding is closed (e.g., the notification is targeted to companies and targeted companies can bid).

Bidders can evaluate the notification and determine if a bid should be submitted and/or contents of the bid. Contents of the bid can include amount paid for integration, restrictions for integration, the dynamic element 125 (e.g., dynamic element to use if the bid is selected), and others. The collection component 1205 can receive a bid set associated with dynamic element integration (e.g., a set of bids for integrating the dynamic element 125 on the adaptable part 120 of the media communication 115).

Bidding can occur automatically, manually, a combination thereof a variety of constraints can be predetermined to resolve bidding in an preset fashion ahead of time, in real-time, or a combination thereof. In this way, determination of dynamic elements can be determined on-the-fly and some sets or subsets can even be split between a plurality of possible dynamic elements in some embodiments.

In one example, two bidders submit bids: Bidder A 1220 and Bidder B 1225. The bid set can include three bids (e.g., bid A1 1230, bid A2 1235, and bid B 1240). Bidder A 1220 can submit two bids: bid A1 1230 and bid A2 1235. In one example, bid A1 1230 provides a smaller payment and an option of a dynamic element 125 for the integration component 110 to integrate while bid A2 1235 provides a higher payment and a specific dynamic element to integrate. Bid A1 1230, bid A2 1235, and bid B 1240 can bid on one adaptable part 120. In one embodiment, a bid does not include the dynamic content 125 (e.g., the system 1200 is notified of the dynamic content 125 after a bid is accepted).

A choice component 1210 can select a winning bid from the bid set. The dynamic element 125 can be associated with the winning bid (e.g., the winning bid is for a dynamic element 125 to be integrated). In one embodiment, the choice component 1210 selects the winning bid based, at least in part, on a bid evaluation result. The bids can be evaluated to produce a bid evaluation result. In one embodiment, the bid evaluation result includes a highest paying bid. In one example, the choice component 1210 selects a highest paying bid. This is one example of a means of selecting a bid, and several alternative selections can be readily ascertained by those skilled in the art.

In one embodiment, the choice component 1210 selects the winning bid based, at least in part, on weighing factors of bids. In one example, bid A1 1230 and bid A2 1235 offer more money than bid B 1240. However, a dynamic element associated with bid B 1240 is more appropriate in a scene of the media communication 115 than a dynamic element associated with bid A1 1230 and bid A2 1235. In one example, a corner bar is shown in the scene and the dynamic element of bid B 1240 is a beer can while the dynamic element of bid A1 1230 and bid A2 1235 is a soda can. The choice component 1210 can weigh an importance of appropriateness against an amount of money offered for a dynamic element to produce the bid evaluation result. The choice component 1210 can use the bid evaluation result to select a winning bid.

In one embodiment, the choice component 1210 selects a bid that is first-in-time as the winning bid. The auction component 1215 can send a notice that the adaptable part 120 is available for integration of a dynamic element 125. A first bid to respond and/or provide a dynamic element 125 can be selected as the winning bid.

In one embodiment, the auction component 1215 functions on passive bids. In one example, a passive bid is a bid submitted without solicitation. The bid can be retained (e.g., in storage of the auction component 1215) and when an appropriate integration opportunity occurs, then the passive bid can be consulted and user in determining an integration. In one example, an active bid is a bid provided in response to a bid request and/or a bid for a specific integration opportunity. Bidders can submit bids for integration of a dynamic element and the collection component 1205 can receive the submitted bids. When an adaptable part 120 is identified, the received bids can be analyzed and based on this analysis the choice component 1210 can select a bid. In one embodiment, the auction component 1215 can hold a bid queue (or plurality thereof).

In one embodiment, the auction component 1215 engages in multiple rounds of bidding and/or leverages bids against one another. In one example, two rival soda companies (e.g., bidder A 1220 and bidder B 1225) can bid for placement of their can in a scene for a particular viewer set (e.g., a specific home, to teenagers attending public high schools, and others). The collection component 1205 can receive and analyze bids from the soda companies. If a bid from bidder A 1220 is better than a bid from bidder B 1225, then the auction component 1215 can notify bidder B. In one example, the auction component 1215 notifies bidder B 1225 of the terms of the bid from bidder A 1220 and asks bidder B 1225 to beat the bid from bidder A. In one example, the auction component 1215 determines a cost characteristic (e.g., how much a bidder pays for dynamic content to be integrated) for bidder B 1225 to beat the bid from bidder A 1220. Multiple rounds of bidding can occur until a winning bid is selected (e.g., other bidders drop out). These rounds can be completed on an arbitrary schedule, on a rolling timetable according to a communication, real-time, or combinations thereof. Other timing schemes for auction-type management are readily appreciable to those skilled in the art, and the foregoing is intended merely to provide some options available to realize the features described supra.

In one embodiment, the auction component 1215 uses at least one artificial intelligence technique. In one example, artificial intelligence techniques are used to determine a tiebreak for tied bids. In one example, a more loyal bidder is selected by the choice component 1210.

In one embodiment, at least part of the auction component 1215 functions before the media communication 115 leaves the communication provider 205 of FIG. 2. In one embodiment, at least part of the auction component 1215 functions before the media communication 115 leaves the distributor 210 of FIG. 2. The media communication 115 can be integrated with different dynamic elements depending on an intended target audience. In one example, distribution is based, at least in part, on a dynamic element 125. In one example, a first version of the media communication 115 is distributed to a first set of disclosure units due to being integrated with a first dynamic element while a second version of the media communication is distributed to a second set of disclosure units due to being integrated with a second dynamic element. In one embodiment, at least part of the auction component 1215 functions while the media communication 115 is retained on the disclosure unit 225 of FIG. 2.

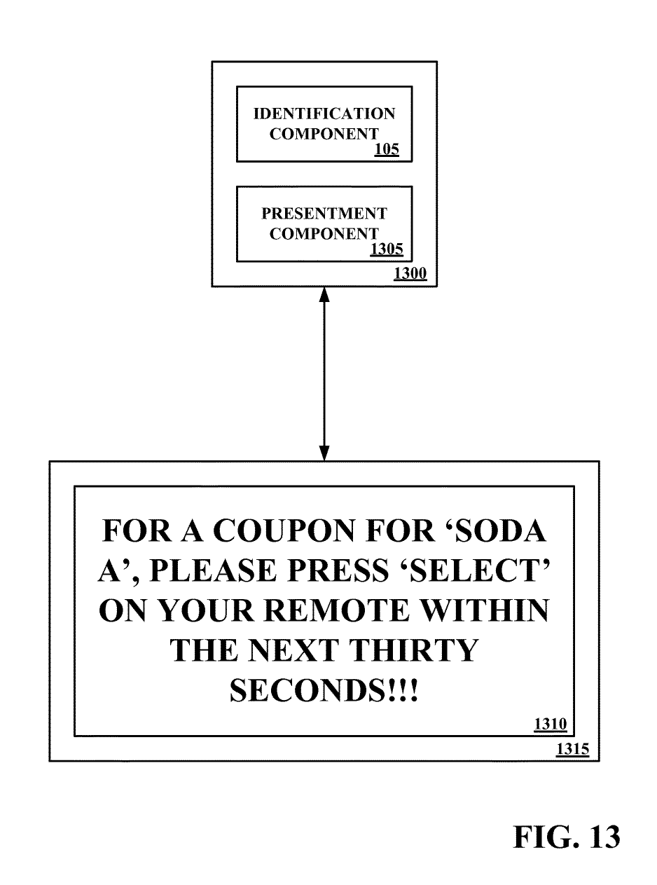

FIG. 13 illustrates one embodiment of a system 1300 with an identification component 1305 and a presentment component 1310. A user can be provided an incentive for watching a media communication (e.g., watching a television program). The incentive can be interactive, passive (e.g. a user accumulates points for watching content), and/or others. Various benefits can be provided to a user in order to increase an influence of one or more communications. Such benefits can include one or more coupons, credits, reductions, accounts, or discounts on cable, Internet or other communication service bills. Such incentives are merely exemplary, and not considered an exhaustive list of possible incentives for viewer sets.

An identification component 105 can identify a media communication. Identification can be general (e.g., a media communication is present in a system), specific (e.g., a media communication with characteristics X, Y, and Z is present in a system), passive (e.g., a media communication is sent through the identification component 105), active (e.g., the identification component 105 seeks out media communications on a system), communicated (e.g., another entity sends a notice to the identification component 105 that a signal is a media communication), and/or be otherwise categorized.

A presentment component 1305 can cause an advertisement that is part of the media communication to be presented. In one embodiment, the presentment component 1305 causes the advertisement to be displayed on a monitor. In one embodiment, the presentment component causes the advertisement to be presented on a television (e.g., the advertisement discloses a real-time opportunity that is a user interactive real-time opportunity).

In one embodiment, the advertisement discloses a real-time opportunity. In one example real-time opportunity, if a user performs a certain function, then the user will be provided an incentive (e.g., provide a coupon, provided a free sample, provided a discount on a bill, provided a credit, be placed in a raffle to win a prize, and/or others).

An advertisement that is presented to a user can be interactive with the user. In one example, a user can watch television. An advertisement 1315 can be displayed that the user can receive a coupon for a product. In one example, the user can press a button on their remote control to order the coupon. In response to the user pressing the button, a mailing system can cause the coupon to be sent to the user (e.g., by way of standard mail, electronic mail, text massage, and/or others).

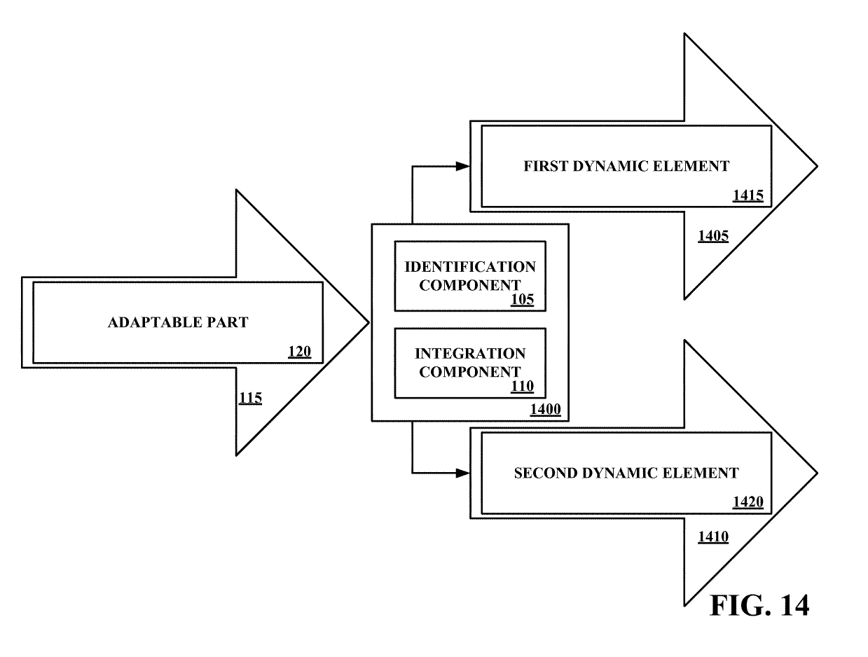

FIG. 14 illustrates one embodiment of a system 1400 that includes an identification component 105 and an integration component 110. The identification component can identify a media communication 115 with an adaptable part 120. An integration component 110 can seamlessly integrate a dynamic element upon the media communication 115.

In one embodiment, the system 100 produces two media communication versions: a first media communication version 1405 and a second media communication version 1410. The first media communication version 1405 can be integrated with a first dynamic element 1415 while the second media communication version 1410 can be integrated with a second dynamic element 1420.

In one embodiment, the first dynamic element 1415 advertises a first product and the second dynamic element 1420 advertises a second product. In one example, the first product and the second product are produced by one company. In one example, the first product and the second product are produced by different companies. In one embodiment, the first dynamic element 1415 and the second dynamic element 1420 advertise one product, but are different advertisements.

In one embodiment, the system 100 works with a single entity to allow different dynamic elements to be displayed to different people at one time. In one example, a financial services company can target one message to high income homes, another to mid-income homes, and a third to lower income households. The identification component 105 can identify incomes of households and/or identify a media communication 115 selected by the financial services company. The integration component 110 can integrate one message into a media communication version that is sent to high income homes (e.g., a message advertising mutual funds with high minimum initial investment amounts), one message into a media communication version that is sent to mid-income homes (e.g., a message advertising mutual funds with low minimum initial investment amounts), and a third media communication version that is sent to low-income homes (e.g., a message advertising credit card consolidation).

The following methodologies are described with reference to figures depicting the methodologies as a series of blocks. These methodologies may be referred to as methods, processes, and others. While shown as a series of blocks, it is to be appreciated that the blocks can occur in different orders and/or concurrently with other blocks. Additionally, blocks may not be required to perform a methodology. For example, if an example methodology shows blocks 1, 2, 3, and 4, it may be possible for the methodology to function with blocks 1-2-4, 1-2, 3-1-4, 2, 1-2-3-4, and others. Blocks may be wholly omitted, re-ordered, repeated or appear in combinations not depicted. Individual blocks or groups of blocks may additionally be combined or separated into multiple components. Furthermore, additional and/or alternative methodologies can employ additional, not illustrated blocks, or supplemental blocks not pictured can be employed in some models or diagrams without deviating from the spirit of the features. In addition, at least a portion of the methodologies described herein may be practiced on a computer-readable medium storing computer-executable instructions that when executed by a computer cause the computer to perform a methodology.

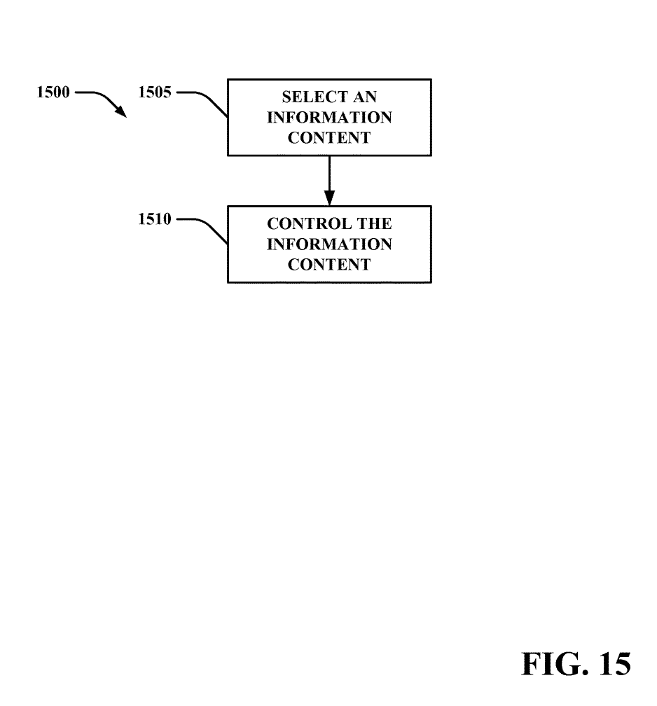

FIG. 15 illustrates one embodiment of a method 1500 that includes making a selection. The method 1500 can be used to select information content for integration within a media communication. At 1505, the method 1500 includes making a selection (e.g., selecting) an information content for integration within a media communication. In one embodiment, selection of the information content can be based, at least in part, on a local viewer set. In one embodiment, 1505 includes selecting a dynamic element to integrate upon an adaptable part of the media communication. At 1510, controlling the information content to integrate within the media communication can occur.

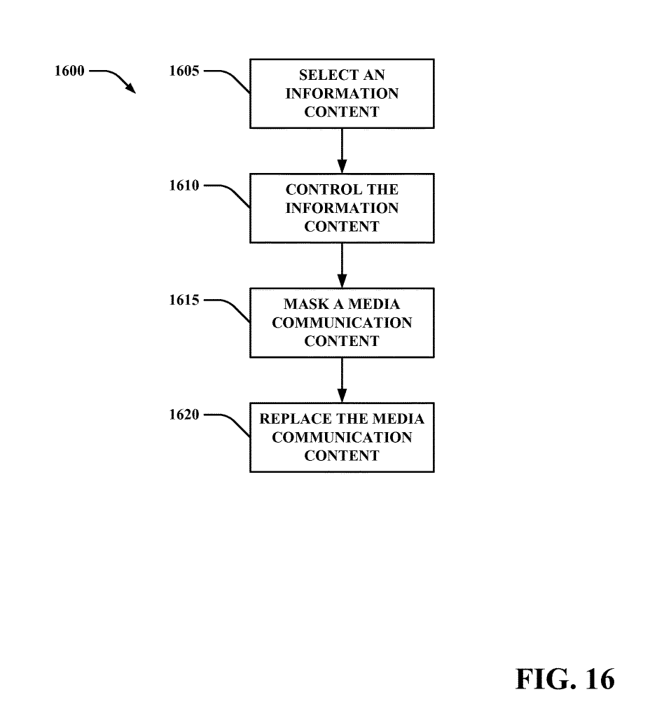

FIG. 16 illustrates one embodiment of a method 1600 that includes selecting an information content. At 1605, the method 1600 includes making a selection (e.g., selecting) an information content for integration within a media communication. Selection of the information content can be based on at least one factor.

In one embodiment, selection of the information content can be based, at least in part, on a local viewer set (e.g., one or more viewers). In one example, specific individuals viewing or anticipated to view the media communication can be evaluated based on age, race, gender, sexual orientation, viewing history, personal preferences, career, income, recent purchases, and/or other demographic or personal characteristics. A result from this evaluation can be used in selecting the content. In one example, an artificial intelligence component can be used to determine content to select. In one example, the local viewer set votes for the information content that the local viewer set would like to see integrated in the media communication.

In one embodiment, selection of the information content can be based, at least in part, on a viewing history of the local viewer set. In one example, the local viewer set can watch television. As the viewer set watches television, the viewing history can be obtained. The viewing history can be analyzed and user to select the information content. In one example, if the viewer set historically watches more cartoons, the integration content can be selected that is in cartoon form where appropriate.

In one embodiment, selection of the information content can be based, at least in part, on a demographic information set of the local viewer set. Example demographic information can include age, race, gender, sexual orientation, career, income, residence, and other personal details. Viewers of the local viewer set can be classified into demographic groups. The demographic groups can be used in selecting information content. In one example, a college-age young adult can be shown information content for a bar while a junior-high child can be shown information content for a batting cage location. In one example, a local viewer set is one user from Cleveland, Ohio that is on a flight from Miami, Fla. to Las Vegas, Nev. Due to the context of a user situation (e.g., where the user is flying to, where the user is flying from, and others), advertisements can be selected that are for Miami and Las Vegas (e.g., advertisements are displayed on a personalized screen on a back of a seat in front of the user). In addition, advertisements for locations can be selected for Cleveland due to that being the user's home. However, if a passenger sitting next to the user is from Ames, Iowa, then advertisements for establishments in Ames can be selected. A group of advertisements can be selected and leveraged off of one another (e.g., so a user does not become over exposed, so advertisements do not inherently compete with one another, to keep a user's attention, et cetera).

In one embodiment, selection of the information content can be based, at least in part, on a local viewer set and a contract agreement. The contract agreement can be an agreement between a provider of information content and an integrator. If metrics established by the provider are met (e.g., the viewer set meets certain criteria), then the content provider can select content to meet the contract agreement (e.g., provider X number of integrations to a type of viewer set, integrate an information content to a type of viewer set over a window of time, and others).

In one embodiment, selection of the information content can be based, at least in part, on a local viewer set and a financial characteristic of the information content. The financial characteristic can include an amount offered for the integration, a cost associated with performing an integration, a negative detriment associated with integration (e.g., an integration that may repulse the local view set and cause the viewer set to watch less content and thus possibly lead to less revenue), and others. In one embodiment, a cheapest information content to integrate can be selected. In other embodiments, various value propositions comprising one or more of fixed and variable metrics can be utilized to select content to integrate.

In one embodiment, selection of the information content can be based, at least in part, on a local viewer set and an appropriateness characteristic of the information content in relation to the local viewer set. The appropriateness characteristic of the information content in relation to the local viewer set can relate to age, religion, personal beliefs, life experience, viewer set mood, contextual information, and other personal preferences not listed for purposes of brevity. In one example, it may be undesirable to show objectionable content to children. Therefore, a cheapest information content may not be selected because children or parents of children may find the cheapest information content objectionable and a second-cheapest content may be then selected. In one embodiment, content that is more appropriate than alternative content may be selected. In one example, if the viewer set is in a bad mood, a more cheerful information content may be selected.

In one embodiment, selection of the information content can be based, at least in part, on the local viewer set and an appropriateness characteristic of the information content in relation to a context of the media communication. The appropriateness characteristic of the information content in relation to a context of the media communication can include if the information content makes sense in a plot of the media communication (e.g., it may be appropriate for a child in the media communication to drink from a soda can, but integrating a beer may be inappropriate), if the information content makes sense in a setting (e.g., a sports car may not be appropriately integrated in an ocean scene), the information content “makes sense” in a context or time period (e.g., a revolver may not be appropriate to integrate in a story set in medieval times), and others.

In one embodiment, the information content is an advertisement. In one embodiment, the advertisement can be a persuasive notification. In one embodiment, the advertisement is a persuasive notification for a viewer to purchase an item. In one embodiment, the information content integrates within the media communication by replacing a media communication advertisement. In one example, at least a portion of the media communication advertisement is part of a scheduled break in the media communication. In one example, at least a portion of the media communication advertisement is at least part of a scene of the media communication.

At 1610, the information content can be controlled. In one embodiment, controlling the information content to integrate within the media communication can occur. In one example, a signal is sent to an integration component. The signal can notify the integration component what information content to integrate, where to integrate the information content, provide authorization, and others. In one embodiment, the information content is controlled to display as integrated within the media communication. In one example, a signal is sent to a disclosure unit. The signal can include the media communication integrated with the information content and an instruction to display the media communication.

At 1615, masking of a media communication content can occur. In one embodiment, the media communication is produced with content. In order for specific content to be integrated on the media content, the produced content can be masked. Masking can include suppressing the media communication content, changing a pointer to the media communication content, and others.

At 1620, replacing the media communication content with the information content occur. In one embodiment, the replacement occurs in conjunction with masking the media communication content. In one embodiment, a direct replacement occurs. In one example, a soda can that is the media communicant content can be replaced with a beer can that is the information content. In one embodiment, a modified replacement occurs. In one example, a soda can that is the media communicant content can be replaced with a beer bottle that is the information content. A modification of the media communication can occur to seamlessly integrate the beer bottle in place of the soda can. In one embodiment, 1615 and 1620 combine to control the information content to integrate within the media communication can occur.

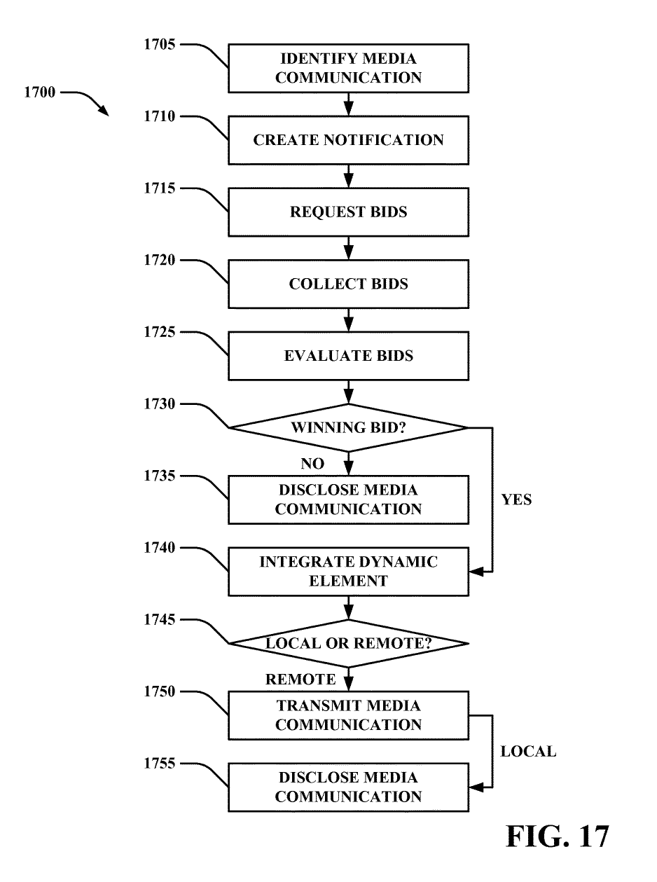

FIG. 17 illustrates one embodiment of a method 1700 that includes identifying a media communication. Multiple parties can compete or intend to place a dynamic element on one adaptable part of a media communication. The adaptable part can be a part of a scene, a commercial break, and others. In one embodiment, the adaptable part is configured to integrate with one dynamic element. If bidding parties cannot be accommodated, then a bidder can be selected. The selected bidder can have their dynamic content integrated upon the adaptable part.

At 1705, a media communication is identified. In one embodiment, the media communication is evaluated and a determination is made based on the evaluation on if an adaptable part exists in the media communication.

At 1710, a notification can be created. The notification can be used to notify potential bidders of an opportunity to have dynamic content integrated upon the adaptable part. Creating the notification can include determining a data set for the notification. In one example, the notification can include parameter information for the adaptable part, a target audience of the media communication, an expected audience of the media communication, a suggested dynamic element type, persuasive information on why to bid on an adaptable part, and others. Such notification parameter information, like other examples provided herein, is intended as only an exemplary list, and not a limiting series. Such examples provide a small number of possibilities among those appreciable by actors skilled in the art.

At 1715, a bid request is sent. In one embodiment, a potential bidder set is identified. The potential bidder set can be bidders predicted to be likely bidders. The notification can be sent to the potential bidder set. In one embodiment, the notification is sent out to one or more entities on a list. In one embodiment, the notification is sent out on open airways.

At 1720, bids can be collected. In one embodiment, collected bids are bids submitted by at least one entity in response to the notification. In one embodiment, unsolicited bids are collected.

At 1725, bids can be evaluated (e.g., collected bids are evaluated). Bid evaluation can include parameter information for the dynamic element, a target audience of the dynamic element, an expected audience of the media communication, a price, a price formula, persuasive information on why the dynamic element should be selected, and others.

At 1730, a determination can be made for a winning bid. In one embodiment, a selection is made on a winning bid. The selection can be based on price offered, appropriateness, relationship with a bidder, outstanding contracts with the bidder, and others. In one embodiment the determination is a determination if a qualifying bid exists. In one example, no bid is submitted. In one example, at least one bid is submitted, but a qualifying bid does not exist (e.g., a bid does not offer money or does not offer enough money).

If there is not a winning bid, then the media communication can be disclosed at 1735. In one embodiment, the media communication is disclosed without a dynamic element integrated on the adaptable part. In one embodiment, a dynamic element is integrated that is not associated with a bidding process and then the media communication is disclosed. In one embodiment, a non-advertisement dynamic element is integrated into the adaptable part and then the media communication is disclosed. In one embodiment, a default dynamic element is integrated into the adaptable part and then the media communication is disclosed.

If there is a winning bid, then a dynamic element can be integrated upon the adaptable part at 1740. At 1745, a determination can be made on if disclosure of the media communication is local or remote (e.g., local or remote to a computer-readable medium operating the method 1700). If the disclosure is remote, then the media communication integrated with the dynamic element can be transmitted at 1750. If disclosure is local, then the media communication integrated with the dynamic element can be disclosed at 1755.

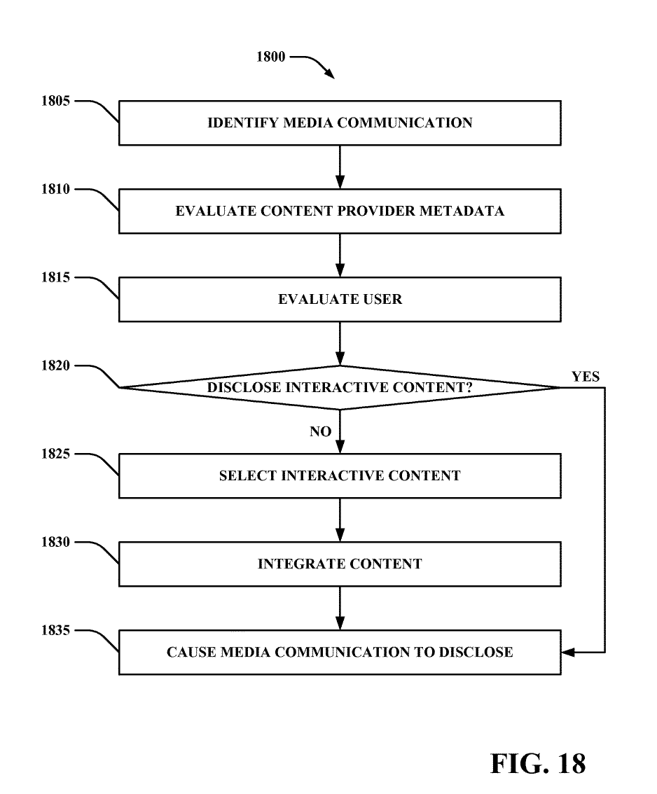

FIG. 18 illustrates one embodiment of a method 1800 that includes integrating content. At 1805, a media communication can be identified. The media communication can be a television program with an advertisement portion. It may be possible for the advertisement portion to be a user interactive real-time opportunity. In one example, a content provider sends a message to an identification component that a real-time opportunity should be disclosed to a user.

At 1810, content provider metadata can be evaluated. This metadata can include users the content provider wants to receive the opportunity, a cost associated with the opportunity (e.g., payment to an integrating unit, payment to a user, and others), trustworthiness of a content provider, and a wide assortment of other metadata.

At 1815, a user can be evaluated. In one example, the opportunity is disclosed to users designated as loyal customers while non-loyal customers do not receive the opportunity. A result of user evaluation can be compared with constraints associated with the opportunity. In one embodiment, a media communication version is selected (e.g., a loyal customer version or a non-loyal customer version).

At 1820, a determination can be made with respect to whether a real-time opportunity should be presented to a user. If the determination is positive, then at 1825 interactive content (e.g., the real-time opportunity that is information content) can be selected. Selection can be based on user viewing history, user demographic data, past purchases of the user, and other considerations.

At 1825, selected content can be integrated. At 1830, after selected content is integrated or if the determination from 1820 is negative, the media communication can be disclosed (e.g., cause the media communication to be presented).

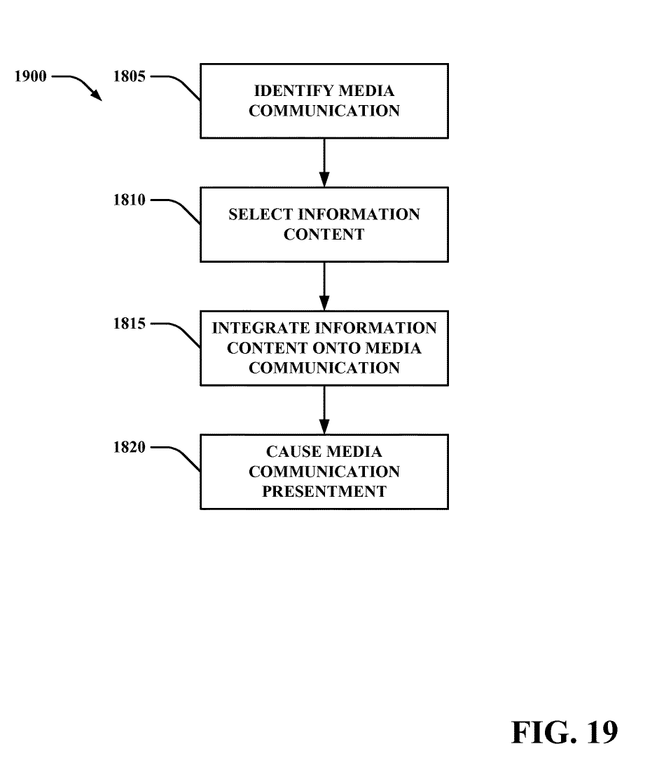

FIG. 19 illustrates one embodiment of a method 1900 that includes identifying a media communication. At 1905, a media communication can be identified. At 1910, there can be selecting an information content for integration within a media communication based, at least in part, on a local viewer set. At 1915, the information content can integrate within the media communication. This can include integrating the information content (e.g., dynamic element) with an adaptable part of the media communication. In one embodiment, the dynamic element is integrated seamlessly with the media communication. At 1920, there can be an advertisement that is part of the media communication to be presented. In one embodiment, the advertisement is the information content. In one embodiment, the advertisement discloses a real-time opportunity.

In one example, data structures may be constructed that facilitate storing data on a computer-readable medium and/or in a data store. Thus, in one example, a computer-readable medium may store a data structure that includes data associated with methods 1500, 1600, 1700, 1800 and 1900 in FIGS. 15, 16, 17, 18, and 19 respectively. In one embodiment, the computer-readable medium can be part of the communication provider 205 of FIG. 2, the distributor 210 of FIG. 2, the satellite 215 of FIG. 2, the relay 220 of FIG. 2, the disclosure unit 225 of FIG. 2, or a combination thereof.

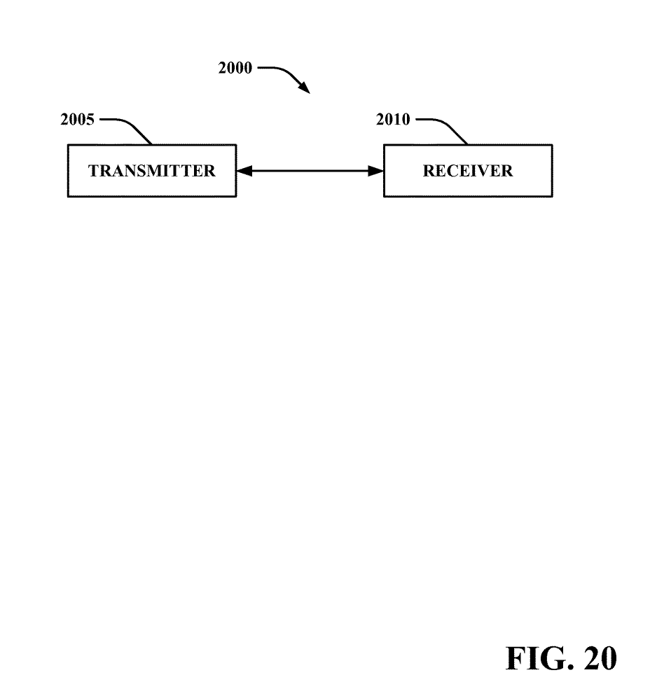

FIG. 20 illustrates one embodiment of a system 2000 that may be used in practicing at least one aspect disclosed herein. The system 2000 includes a transmitter 2005 and a receiver 2010. In one or more embodiments, the transmitter 2005 can include reception capabilities and/or the receiver 2010 can include transmission capabilities. The transmitter 2005 and receiver 2010 can each function as a client, a server, and others. The transmitter 2005 and receiver 2010 can each include a computer-readable medium used in operation. The computer-readable medium may include instructions that are executed by the transmitter 2005 or receiver 2010 to cause the transmitter 2005 or receiver to perform a method. The transmitter 2005 and receiver 2010 can engage in a communication with one another. This communication can over a communication medium. Example communication mediums include an intranet, an extranet, the Internet, a secured communication channel, an unsecure communication channel, radio airwaves, a hardwired channel, a wireless channel, and others. Example transmitters 2005 include a base station, a personal computer, a cellular telephone, a personal digital assistant, and others. Example receivers 2010 include a base station, a cellular telephone, personal computer, personal digital assistant, and others. The example network system 2000 may function along a Local Access Network (LAN), Wide Area Network (WAN), and others. In one embodiment, aspects disclosed herein, including communication across the network system 2000 can include security measures (e.g., encryption, decryption, keys, and others). The aspects described are merely an example of network structures and intended to generally describe, rather than limit, network and/or remote applications of features described herein.

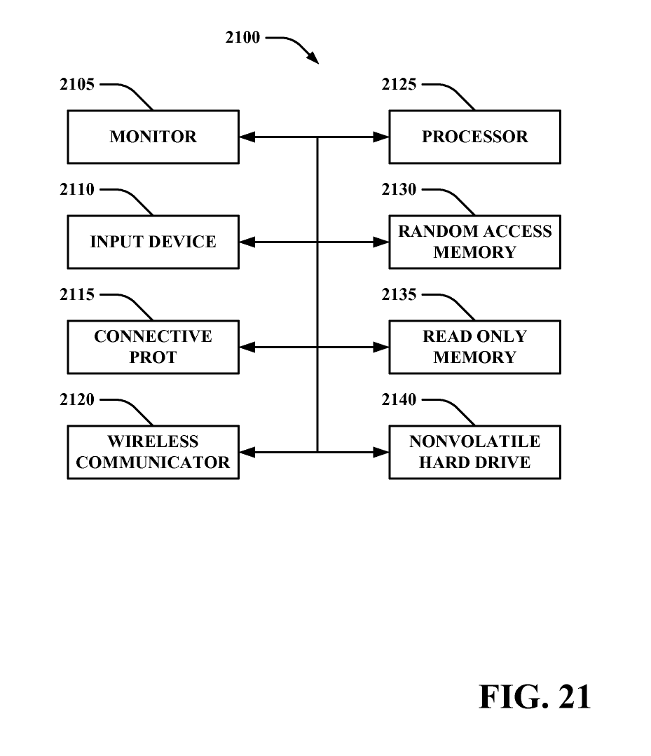

FIG. 21 illustrates one embodiment of a system 2100, upon which at least one aspect disclosed herein can be practiced. In one embodiment, the system 2100 can be considered a computer system that can function in a stand-alone manner as well as communicate with other devices (e.g., a central server, communicate with devices through data network (e.g., Internet) communication, etc). Information can be displayed through use of a monitor 2105 and a user can provide information through an input device 2110 (e.g., keyboard, mouse, touch screen, etc.). In one embodiment, the monitor 2105 is used to display the media communication. A connective port 2115 can be used to engage the system 2100 with other entities, such as a universal bus port, telephone line, attachment for external hard drive, and the like. Additionally, a wireless communicator 2120 can be employed (e.g., that uses an antenna) to wirelessly engage the system 2100 with another device (e.g., in a secure manner with encryption, over open airwaves, and others). A processor 2125 can be used to execute applications and instructions that relate to the system 2100. Storage can be used by the system 2100. The storage can be a form of a computer-readable medium. Example storage includes random access memory 2130, read only memory 2135, or nonvolatile hard drive 2140.

The system 2100 may run program modules. Program modules can include routines, programs, components, data structures, logic, etc., that perform particular tasks or implement particular abstract data types. The system 2100 can function as a single-processor or multiprocessor computer system, minicomputer, mainframe computer, laptop computer, desktop computer, hand-held computing devices, microprocessor-based or programmable consumer electronics, and the like.

It is to be appreciated that aspects disclosed herein can be practiced through use of artificial intelligence techniques. In one example, a determination or inference described herein can, in one embodiment, be made through use of a Bayesian model, Markov model, statistical projection, neural networks, classifiers (e.g., linear, non-linear, etc.), using provers to analyze logical relationships, rule-based systems, or other technique.

While example systems, methods, and so forth have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, innovative aspects are not limited to the specific details, the representative apparatus, and illustrative examples shown and described. Thus, this application is intended to embrace alterations, modifications, and variations that fall within the scope of the appended claims.

Functionality described as being performed by one entity (e.g., component, hardware item, and others) may be performed by other entities, and individual aspects can be performed by a plurality of entities simultaneously or otherwise. For example, functionality may be described as being performed by a processor. One skilled in the art will appreciate that this functionality can be performed by different processor types (e.g., a single-core processor, quad-core processor, etc.), different processor quantities (e.g., one processor, two processors, etc.), a processor with other entities (e.g., a processor and storage), a non-processor entity (e.g., mechanical device), and others.

In addition, unless otherwise stated, functionality described as a system may function as part of a method, an apparatus, a method executed by a computer-readable medium, and other embodiments may be implemented in other embodiments. In one example, functionality included in a system may also be part of a method, apparatus, and others.

Where possible, example items may be combined in at least some embodiments. In one example, example items include A, B, C, and others. Thus, possible combinations include A, AB, AC, ABC, AAACCCC, AB. Other combinations and permutations are considered in this way, to include a potentially endless number of items or duplicates thereof.

1-17. (canceled)

18. A system, comprising:
a sensor used to determine user activity; and
a non-transitory computer readable medium configured to store at least:
an identification component that identifies a media communication and a dynamic element, wherein the dynamic element is within the media communication and less than all the media communication;
a presentment component that presents an advertisement as the dynamic element, wherein the advertisement is selected based on a real-time update to an advertisement context;
an observation component that analyzes the user activity during presentation of the advertisement; and
a calculation component that determines a price to the advertiser for the advertisement based on the user activity, wherein the price varies based on an impact to the user.

19. The system of claim 18, where the advertisement context includes a time of presentment, and the time of presentment is unscheduled.

20. The system of claim 18, wherein the impact to the user is a negative reaction, and wherein the calculation component reduces the price based on the negative reaction.

21. The system of claim 18, where the advertisement context is based at least in part on an ongoing event in a channel of mass media, wherein the ongoing event is a tragic news story, and wherein the advertisement is selected to exclude humorous advertisements.

22. The system of claim 18, where the advertisement context is based at least in part on a user profile that is updated based on user activity during presentment of the media communication based on the user activity.

23. The system of claim 18, wherein the sensor detects movement of a movement of the user.

24. The system of claim 23, where the impact is based at least in part on the movement of the user targeted to view the advertisement.

25-37. (canceled)

38. The system of claim 18, wherein the user activity includes user eye focus, and wherein the impact is based on whether the user eye focus is on the advertisement.

39. A television set, comprising:
a sensor that determines an activity of a viewer of the television set;
an identification component that identifies a media communication having an adaptable part;
an integration component that integrates a dynamic element including an advertisement onto the adaptable part of the media communication;
an observation component that analyzes the activity during presentation of the dynamic element to determine a reaction; and
a calculation component that determines a price to the advertiser for the advertisement based on the reaction, wherein the price varies based on an impact to the viewer.

40. The television set of claim 39, wherein the sensor is a camera that collects video data, wherein the video data includes eye focus of the viewer, and wherein the observation component determines the reaction based on the eye focus.

41. The television set of claim 39, wherein the sensor is a camera that collects video data, and wherein the video data includes location data of the viewer, wherein the location data indicates the viewer departing during presentation of the dynamic element, and wherein the observation component determines the reaction based on the viewer departing.

42. The television set of claim 39, wherein the sensor is a microphone, and wherein the activity includes a voice of the viewer.

43. The television set of claim 42, wherein the observation component determines an observation result indicating the voice of the viewer is unrelated to the dynamic element in, wherein the observation component determines the advertisement is ineffective based on the observation result, and wherein the calculation component reduces the price based on the advertisement being ineffective.

44. The television set of claim 39, wherein the observation component determines an observation result that the viewer reduced a volume of the television set or changed a channel of the television set during presentation of the dynamic element, wherein the observation component determines the advertisement is ineffective based on the observation result, and wherein the calculation component reduces the price based on the advertisement being ineffective.

45. A set top box configured to communicate with a display, comprising:
a sensor that determines an activity of a viewer of the display;
an identification component that identifies a media communication having an adaptable part;
an integration component that integrates a dynamic element onto the adaptable part of the media communication; and
an observation component that determines an observation result based on the activity,
wherein the viewer is provided an incentive based on the observation result.

46. The set top box of claim 45, wherein the sensor is a microphone, wherein the activity is a verbal criticism related to product pricing associated with the dynamic element, and wherein the incentive reduces the product pricing based on the verbal criticism.

47. The set top box of claim 45, wherein the sensor is a camera, wherein the camera monitors eye focus of the viewer of the display, and wherein the incentive is related to the eye focus of the viewer.

48. The set top box of claim 47, wherein the eye focus is on the dynamic element, and wherein the incentive is related to the dynamic element.

49. The set top box of claim 47, wherein the eye focus is not on the dynamic element, and wherein the incentive is related to the dynamic element.

50. The set top box of claim 45, wherein the activity of the viewer of the display is further based on an input from a user input device in control of the viewer of the display, and wherein the user device is one of a remote control or a typing device.
